(19) United States
(12) Patent Application Publication
(10) Pub. No.: US 2010/0277949 A1
(43) Pub. Date: Nov. 4, 2010

(54) Light guide plate and backlight module

(75) Inventors: Chao-Hung Weng, Hsinchu (TW); Jyh-Ming Chen, Hsinchu (TW); Kuo-Tung Tiao, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/654,328

(22) Filed: Dec. 17, 2009

(30) Foreign Application Priority Data
Apr. 30, 2009 (TW) 098114605

(51) Int. Cl. F21V 7/04

(52) U.S. Cl. 362/607; 362/623

(57) ABSTRACT

A light guide plate adapted to guide a beam emitted from at least one light emitting device and including a light transmissive substrate and a plurality of optical structures is provided. The light transmissive substrate has a light emitting surface, a bottom surface opposite to the light emitting surface, and a light incident surface connecting the light emitting surface and the bottom surface. The beam from the light emitting device enters the light transmissive substrate through the light incident surface and is emitted out. The optical structures are disposed on the bottom surface and each of the optical structures has a first total internal reflection (TIR) surface and a second TIR surface. A part of the beam from the light incident surface is totally internally reflected by the first TIR surface and the second TIR surface in sequence. A backlight module using the light guide plate is also provided.

### CROSS-REFERENCE TO RELATED APPLICATION

This application claims the priority benefit of Taiwan application serial no. 098114605, filed on Apr. 30, 2009. The entirety of the above-mentioned patent application is hereby incorporated by reference herein and made a part of this specification.

### BACKGROUND OF THE INVENTION

1. Field of the Invention

The invention generally relates to a backlight module and an optical component of the backlight module, and more particularly, to a side type backlight module and a light guide plate.

2. Description of Related Art

A liquid crystal display has a liquid crystal panel and a backlight module, wherein the backlight module is disposed behind the liquid crystal panel and provides the surface light source of the liquid crystal panel. According to the positions of the light emitting device, the backlight module may be categorized into a direct type backlight module and a side type backlight module. In the side type backlight module, a light guide plate is disposed for guiding a light beam emitted from the light emitting device disposed at one side of the light guide plate, so as to provide the surface light source to the liquid crystal panel. Besides, the backlight module may also be categorized into a light emitting diode (LED) backlight module and a cold cathode fluorescent lamp (CCFL) backlight module according to the type of the light emitting device adopted in the backlight module.

In the side type backlight module having a plurality of LEDs as the light emitting devices, the LEDs are disposed beside an incident surface in the light guide plate, and the LEDs are arranged on a straight line and are kept away from each other. The LEDs emit a plurality of light beams, wherein the light beams enter the light guide plate through the incident surface of the light guide plate. Because the LEDs have high directivity (i.e., have a limited light emitting angle range), bright regions are formed in the light guide plate within the light emitting angle range and close to the LEDs, and dark regions are formed in the light guide plate outside of the light emitting angle range. The light guide plate may not be able to provide a uniform surface light source due to the existence of these bright and dark regions, and this is referred to as the hot spot phenomenon. Along with the constant increase of LED power in recent years, the number of LEDs disposed at one side of the incident surface in the light guide plate is reduced. However, since fewer LEDs are disposed, the space between every two adjacent LEDs is increased. As a result, the area of the dark areas is increased, and accordingly the surface light source becomes even more uneven and the problem of hot spot is worsened.

Nowadays, in order to solve the referred hot spot phenomenon, a method of making diffusion structure in the light incident surface of the light guide plate by end face working is provided to increase the angle of the light emitting to the light guide plate; or as disclosed in the U.S. Pat. No. 7,364,338, a method of arraying the LEDs in different angles to increase the light emitting angle is provided. However the method of making diffusion structure by end face working may easily produce defect in image, the method of arraying the LEDs in different angles may make the light guide plate thick, and the two methods may increase the manufacture cost.

### SUMMARY OF THE INVENTION

The invention is directed to a light guide plate capable of effectively solving the problem of hot spot problem.

The invention is directed to a backlight module capable of providing a uniform surface light source.

Other objectives and advantages of the invention will be further understood from the technological features disclosed by the invention.

To achieve at least one of the above-mentioned advantages, an embodiment of the invention provides a light guide plate adapted to guide a light beam emitted from at least one light emitting device. The light guide plate includes a light transmissive substrate and a plurality of optical structures. The light transmissive substrate has a light emitting surface, a bottom surface opposite to the light emitting surface, and a light incident surface connecting the light emitting surface and the bottom surface, wherein the light beam emitted from the at least one light emitting device is capable of entering the light transmissive substrate through the light incident surface and is capable of being emitted out of the light transmissive substrate through the light emitting surface. The optical structures are disposed on the bottom surface. Each of the optical structures has a first surface and a second surface connecting the bottom surface and the first surface, wherein the first surface is opposite to the bottom surface, and a part of the light beam emitted from the light incident surface is capable of entering the light guide plate through being totally internally reflected by the first surface and the second surface in sequence.

In one embodiment of the invention, a first included angle is formed between the first surface and the second surface, and the range of the first included angle is between 95 degrees and 135 degrees. In one embodiment of the invention, the range of the first included angle is between 110 degrees and 125 degrees.

In one embodiment of the invention, a second included angle is formed between the part of the light beam transmitted to the second surface through being totally internally reflected by the first surface and a normal vector of the second surface, and the range of the second included angle is between 0 degree and 50 degrees.

In one embodiment of the invention, the light guide plate further includes a plurality of net point structures disposed on the bottom surface of the light guide plate, and the net point structures are disposed between the optical structures.

In one embodiment of the invention, the first surface is a plane surface, the second surface is a curved surface, and the second surface surrounds the first surface.

In one embodiment of the invention, each of the first surface and the second surface is a curved surface and the second surface surrounds the first surface.

In one embodiment of the invention, the second surface is a plane surface with multiple continuous sections.

In one embodiment of the invention, the density of the optical structures in the area close to the light incident surface is greater than the density of the optical structures in the area far away from the light incident surface.

The other embodiment of the invention provides a backlight module. The backlight module includes a plurality of light emitting devices and the light guide plate as described above. Each of the light emitting devices is capable of emitting a light beam, and the light guide plate is disposed in the transmission path of the light beams. The light beams emitted from the light emitting devices are capable of entering the light transmissive substrate through the light incident surface and a part of the light beams from the light incident surface is capable of entering the light guide plate through being totally reflected by the first surface and the second surface in sequence.

In one embodiment of the invention, the light emitting devices include a light emitting diode.

The embodiment or the embodiments of the invention may have at least one of the following advantages. In the light guide plate of the embodiment of the invention, because a part of the light beam emitted from the light emitting device may enter the light guide plate through the optical structures of the light guide plate through being totally internally reflected twice, the optical structures may make a part of the light beam rebound to the areas which are close to the light incident surface of light guide plate and at both sides of the optical axes of the light emitting device, so that the problem of the hot spot may be resolved and the uniformity of the surface light source provided by the backlight module adopting the light guide plate may be improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a cross-sectional diagram of the backlight module according to the first embodiment of the invention.

FIG. 1B is a top view of the backlight module in FIG. 1A.

FIG. 1C is a partial enlarged drawing of optical structure of the light guide plate in FIG. 1A.

FIG. 1D is a solid diagram of the optical structure of the light guide plate in FIG. 1A.

FIG. 2 is a cross-sectional diagram of the backlight module according to the second embodiment of the invention.

FIG. 3 is a cross-sectional diagram of the backlight module according to the third embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### The First Embodiment

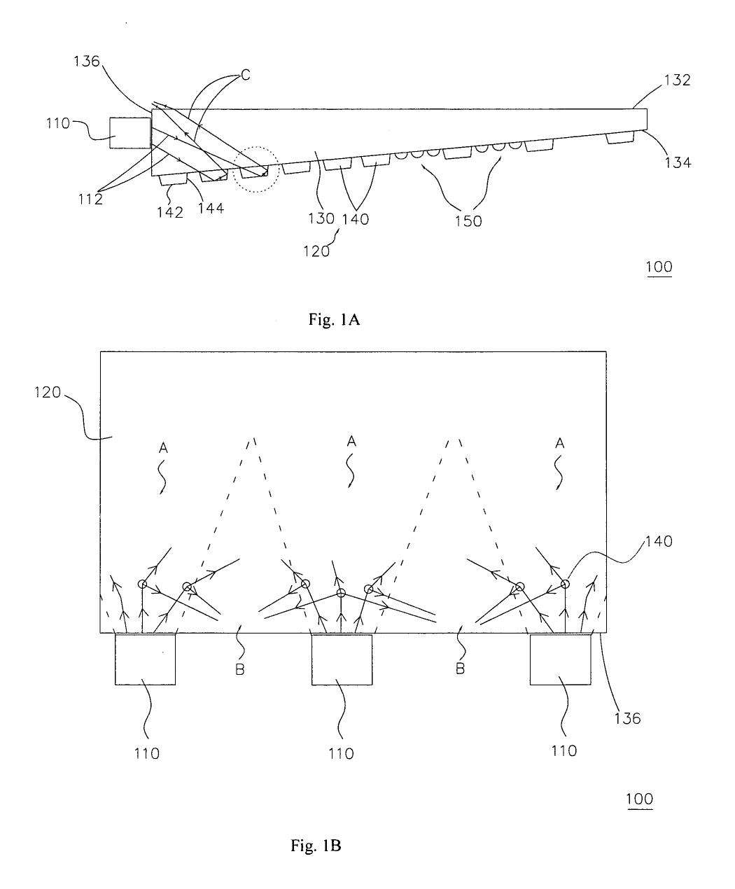

Referring to FIGS. 1A to 1D, a backlight module 100 of an embodiment is, for example, a side type backlight module. The backlight module 100 includes a plurality of light emitting devices 110 (three are three in FIG. 1B) and a light guide plate 120. Each of the light emitting devices 110 is capable of emitting a light beam 112. In the embodiment, each of the light emitting devices 110 is, for example, a light emitting diode. The light guide plate 120 is disposed in the transmission path of the light beams 112 and adapted to guide the light beams 112 emitted from light emitting devices 110. The light guide plate 120 may further include a light transmissive substrate 130 and a plurality of optical structures 140. The light transmissive substrate 130 has a light emitting surface 132, a bottom surface 134 opposite to the light emitting surface 132, and a light incident surface 136 connecting the light emitting surface 132 and the bottom surface 134. Besides, in the embodiment, the light emitting devices 110 may be disposed beside the light incident surface 136 of the light transmissive substrate 130. Furthermore, because the LEDs have directivity, each of the light emitting devices 110 has a light emitting angle range A. The light beams 112 emitted from the light emitting devices 110 may enter the light transmissive substrate 130 through the light incident surface 136, and is emitted out of the light transmissive substrate 130 through the light emitting surface 132. The optical structures 140 are disposed on the bottom surface 134. Each of the optical structures 140 has a first surface 142 and a second surface 144 connecting the bottom surface 134 and the first surface 142, wherein the first surface 142 is opposite to the bottom surface 134, and a part of the light beams 112 from the light incident surface 136 may enter the light guide plate 120 through being totally internally reflected by the first surface 142 and the second surface 144 in sequence. In the embodiment, the first surface 142 is a plane surface, the second surface 144 is a curved surface, and the second surface 144 surrounds the first surface 142. Each of the optical structures 140 is a platform type convex structure, and a first included angle θ is formed between the first surface 142 and the second surface 144, the range of the first included angle θ is between 95 degrees and 135 degrees. Besides, in one embodiment, the range of the first included θ angle may be between 110 degrees and 125 degrees. Furthermore, the optical structures 140 are made on the bottom surface 134 of the light guide plate 120 by injection molding, ink jet, screen printing or other etching methods. In an embodiment, the optical structures 140 and the light transmissive substrate 130 are integrally formed.

As described above, a part of the light beams 112 from the light incident surface 136 may enter the light guide plate 120 through being totally internally reflected by the first surface 142 and the second surface 144 in sequence. To be detailed, the light beams from the light emitting devices 110 enter the light guide plate 120 through the light incident surface 136, wherein a part of the light beams 112 may enter the first surface 142 of the optical structures 140, be totally internally reflected on the first surface 142 to form the reflected light beams 112, and be transmitted to the second surface 144. A part of the reflected light beams 112 is totally reflected by the second surface 144 to form rebounding light beams C, and then the rebounding light beams C are transmitted to the light guide plate 120. A second included angle β is formed between the part of the reflected light beams 112 totally internally reflected by the first surface 142 and a normal vector N of the second surface 144, and the range of the second included angle β is between 0 degree and 50 degrees. However, in the embodiment, the optical structures 140 close to the light incident surface 136 may make a part of the light beams 112 emitted from the light emitting devices 110 rebound to the dark areas B between the two adjacent light emitting devices 110 as described in FIG. 1B to compensate the light emitting intensity in the dark areas B. The dark areas B are the areas out of light emitting angle range A of the light emitting devices 110. The optical structures 140 may make the part of the light beams 112 emitted from the light emitting devices 110 to rebound to the dark areas B, so that the light emitting intensity in the light emitting angle range A of the light emitting devices 110 may be reduced. Because of this, the light guide plate 120 may effectively solve the hot spot phenomenon and the whole backlight module 110 also may provide more uniform surface light.

Besides, the light guide plate 120 further includes a plurality of diffusion net point structures 150 as FIG. 1A. The diffusion net point structures 150 are disposed on the bottom surface 134 of the light guide plate 120 and are distributed between the optical structures 140 proportionally. In the embodiment, the diffusion net point structures are, for example, TiO₂ net points or other net points made from the material suitable to diffuse light. However, in other embodiment, the diffusion net structures 150 may be concave or convex spot on the bottom surface 134. To be detailed, when the light beams 112 entering the light guide plate 120 is transmitted to the diffusion net point structures 150, the light beams 112 may be diffused because of the diffusion effect of the diffusion net point structures 150, so that the uniformity of the light emitted from the light guide plate 120 is improved. In the embodiment of the invention, the diffusion net point structures 150 may be made by method of screen printing, photolithograph or other etching method.

In the embodiment of the invention, the density of the optical structures 140 in the area close to the light incident surface 136 is greater than the density of the optical structures 140 in the area far away from the light incident surface 136. Thereby, more rebounding light beams C may be transmitted to the light emitting surface 132 in the area close to the light incident surface 136 of the light guide plate 120, to compensate the intensity of the light in the dark areas B.

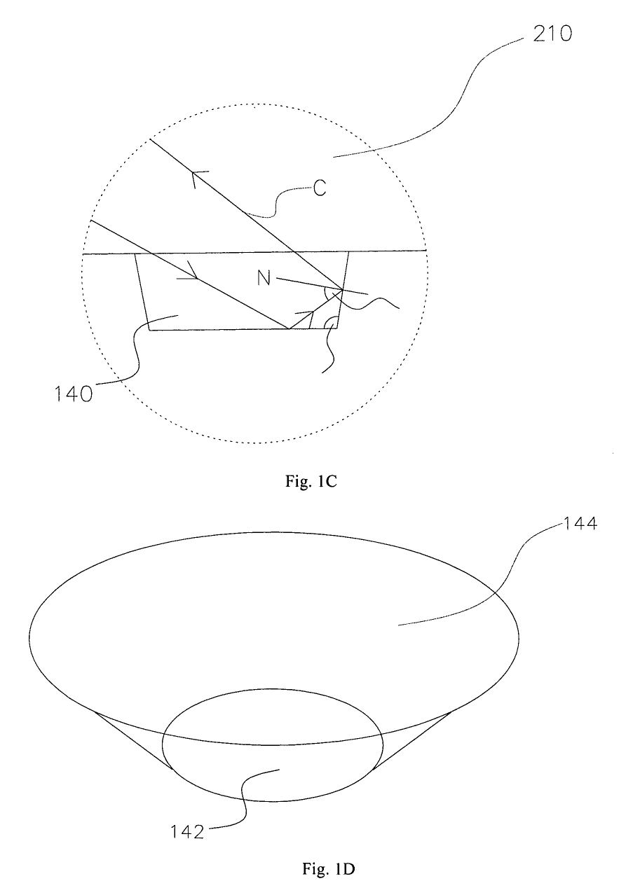

Referring to FIG. 2, the backlight module 200 in the embodiment is similar to the backlight module 100 described above (referring to FIG. 1A). The difference between the backlight module 200 and the backlight module 100 is that each of the first surface 242 and the second surface 244 of the optical structures 240 in backlight module 200 of the embodiment is a curved surface, the second surface 244 surrounds the first surface 242, and the optical structures 240 include a paraboloid convex structure. The light guide plate 220 has similar advantage and effect with the light guide plate 120 (referring to FIG. 1A).

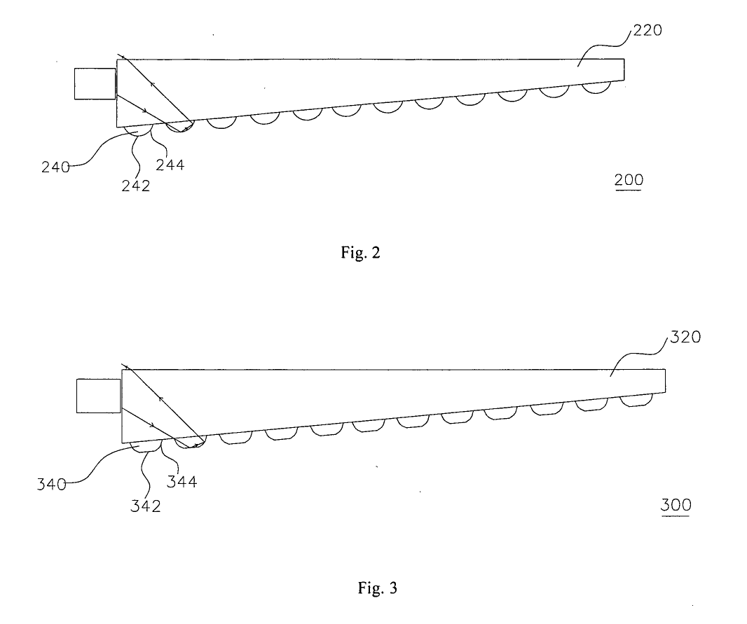

Referring to FIG. 3, the backlight module 300 in the embodiment is similar to the backlight module 100 described above (referring to FIG. 1A). The difference between the backlight module 300 and the backlight module 100 is that the first surface 342 of the optical structures 340 in the backlight module 300 of the embodiment is a plane surface, the second surface 344 of the optical structures 340 in the backlight module 300 of the embodiment is a plane surface with multiple continuous sections, the second surface 344 surrounds the first surface 342, and the optical structures 340 include a polyhedron convex structure. The light guide plate 320 has similar advantage and effect with the light guide plate 120 (referring to FIG. 1A).

Above all, the embodiment or the embodiments of the invention may have at least one of the following advantages, in the light guide plate and backlight module of the embodiment of the invention, because part of the light beams emitted from the light emitting devices may enter the light guide plate through being totally internally reflected twice in the optical structures of the light guide plate, that is to say, the optical structures may make part of the light beams rebound to the areas which are close to the light incident surface of light guide plate and at both sides of the optical axes of the light emitting devices, so that the problem of the hot spot may be resolved and the uniformity of the surface light source provided by the backlight module adopting the light guide plate may be improved, and the number of the light source is not increased in the embodiment of the invention. The backlight module in the embodiment of the invention may not only provide uniform surface light source but also have lower cost.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide plate, adapted to guide a light beam emitted from at least one light emitting device, the light guide plate comprising:
a light transmissive substrate, having a light emitting surface, a bottom surface opposite to the light emitting surface, and a light incident surface connecting the light emitting surface and the bottom surface, wherein the light beam emitted from the at least one light emitting device is capable of entering the light transmissive substrate through the light incident surface and is capable of being emitted out of the light transmissive substrate through the light emitting surface; and
a plurality of optical structures, disposed on the bottom surface, each of the optical structures having a first surface and a second surface connecting the bottom surface and the first surface, wherein the first surface is opposite to the bottom surface, and a part of the light beam from the light incident surface is capable of entering the light guide plate through being totally internally reflected by the first surface and the second surface in sequence.

2. The light guide plate according to claim 1, wherein a first included angle is formed between the first surface and the second surface, and the range of the first included angle is between 95 degrees and 135 degrees.

3. The light guide plate according to claim 2, wherein the range of the first included angle is between 110 degrees and 125 degrees.

4. The light guide plate according to claim 1, wherein a second included angle is formed between the part of the light beam transmitted to the second surface through being totally internally reflected by the first surface and a normal vector of the second surface, and the range of the second included angle is between 0 degree and 50 degrees.

5. The light guide plate according to claim 1, wherein the light guide plate further comprises a plurality of net point structures disposed on the bottom surface of the light guide plate, and the net point structures are disposed between the optical structures.

6. The light guide plate according to claim 1, wherein the first surface is a plane surface, the second surface is a curved surface, and the second surface surrounds the first surface.

7. The light guide plate according to claim 1, wherein each of the first surface and the second surface is a curved surface and the second surface surrounds the first surface.

8. The light guide plate according to claim 1, wherein the second surface is a plane surface with multiple continuous sections.

9. The light guide plate according to claim 1, wherein the density of the optical structures in the area close to the light incident surface is greater than the density of the optical structures in the area far away from the light incident surface.

10. A backlight module, comprising:
a plurality of light emitting devices, each of the light emitting devices capable of emitting a light beam; and
a light guide plate, disposed in a transmission path of the light beams, the light guide plate comprising:
a light transmissive substrate, having a light emitting surface, a bottom surface opposite to the light emitting surface, and a light incident surface connecting the light emitting surface and the bottom surface, wherein the light beams emitted from the light emitting devices are capable of entering the light transmissive substrate through the light incident surface and are capable of being emitted out of the light transmissive substrate through the light emitting surface; and
a plurality of optical structures, disposed on the bottom surface, each of the optical structures having a first surface and a second surface connecting the bottom surface and the first surface, wherein the first surface is opposite to the bottom surface, and a part of the light beams from the light incident surface is capable of entering the light guide plate through being totally internally reflected by the first surface and the second surface in sequence.

11. The backlight module according to claim 10, wherein the light emitting devices comprise a light emitting diode.

12. The backlight module according to claim 10, wherein a first included angle is formed between the first surface and the second surface, and the range of the first angle is between 95 degrees and 135 degrees.

13. The backlight module according to claim 12, wherein the range of the first angle is between 110 degrees and 125 degrees.

14. The backlight module according to claim 10, wherein a second included angle is formed between the part of the light beams transmitted to the second surface through being totally internally reflected by the first surface and a normal vector of the second surface, and the range of the second included angle is between 0 degree and 50 degrees.

15. The backlight module according to claim 10, wherein the light guide plate further comprises a plurality of net point structures disposed on the bottom surface of the light guide plate, and the net point structures are disposed between the optical structures.

16. The backlight module according to claim 10, wherein the optical structures comprise a platform type convex structure, a paraboloid convex structure, or a polyhedron convex structure.

17. The backlight module according to claim 10, wherein the density of the optical structures in the area close to the light incident surface is greater than the density of the optical structures in the area far away from the light incident surface.
